(19) United States
(12) Patent Application Publication
(10) Pub. No.: US 2022/0036743 A1
(43) Pub. Date: Feb. 3, 2022

(54) LOW-ALTITUDE AIR ROUTE PLANNING AND DESIGN METHOD, DEVICE AND STORAGE MEDIUM WITH MULTI-OBJECTIVE CONSTRAINTS

(71) Applicant: Beihang University, Beijing (CN)

(72) Inventors: Xianbin Cao, Beijing (CN); Wenbo Du, Beijing (CN); Siyuan Li, Beijing (CN); Mingyuan Zhang, Beijing (CN)

(73) Assignee: Beihang University, Beijing (CN)

(21) Appl. No.: 17/115,287

(22) Filed: Dec. 8, 2020

(30) Foreign Application Priority Data
Jul. 29, 2020 (CN) 2020107466830

(51) Int. Cl. G08G 5/00; G08G 5/04; B64C 39/02

(52) U.S. Cl. CPC G08G 5/0034; G08G 5/0039; G08G 5/0013; B64C 2201/141; G08G 5/04; B64C 39/024; G08G 5/0043

(57) ABSTRACT

The application discloses a low-altitude air route planning and design method, device and storage medium for UAV with multi-objective constraints. First of all, initial air route points and air route network are set based on the urban low-altitude demand, then constraints such as conflict constraints, three zones constraints, and traffic demand constraints are introduced, the optimal multi-objective function such as the airspace capacity, operation cost, operation safety and so on is realized by moving air route points and reconstructing air route network, and the low-altitude air route networks of corresponding UAV is designed for different low-altitude environments.

### CROSS-REFERENCE TO RELATED APPLICATIONS

This application claims priority to Chinese Patent Application No. 202010746683.0, filed on Jul. 29, 2020, which is hereby incorporated by reference in its entirety.

### TECHNICAL FIELD

The application belongs to the technical field of UAV air route planning. According to the requirements, the air route points and the initial air route network are constructed, and multiple constraint conditions are set to achieve the optimal multi-objective function by moving air route points and reconstructing the air route network, and then the low-altitude air route network of UAV is designed.

### BACKGROUND

In UTM scenario, the related research of low-altitude UAV in city is mainly on flight planning, while air route network planning is less. Due to the continuity and complexity of urban low-altitude airspace, in order to reduce the complexity, more Grid method (Grid) can be applied to the current environmental research of building the airspace to establish low-altitude airspace environment of a low-altitude UAV, the Grid represents the three-dimensional geographic information mapping to the Grid, firstly, the airspace environment is divided into Grid blocks, and then according to the air point (communication point, airport, temporary land area, land waiting area, etc.) in a Grid, restricted area and capabilities of communication, navigation and surveillance, the Grid can be divided into obstacle Grid and free Grid.

Since then, the airspace environment consists of free grid and obstacle grid, and forms a connected graph. In this way, the route planning problem is transformed into a free grid planning problem, that is, the optimal path to avoid obstacles from the initial grid to the endpoint grid is found on the connected graph.

The main features of the aviation network in UTM scenario include: Low-altitude UAV air route network, which has the following characteristics compared with traditional aircraft. Firstly, the distribution of obstacles is more complex due to the low altitude of the city. Secondly, urban UAV nodes are more dispersed, and compared with the known airport of traditional aircraft, node location needs to be determined first. Finally, UAV has a high density and significant dynamic change, so it requires high real-time performance of the model. It may need to make corresponding adjustments to the air route network in different time periods. Therefore, a route planning and design method for low altitude UAV with multi-objective constraints is needed to set up the air route network.

### SUMMARY

The application provides a low-altitude air route planning and design method, device and storage medium for UAV with multi-objective constraints. According to the requirements, the air route points and the initial air route network are constructed, multiple constraints are set, and the optimal multi-objective function is achieved by moving the air route points and reconstructing the air route network, and then the low-altitude air route network of UAV is designed.

The application provides a low-altitude air route planning and design method for UAV with multi-objective constraints, its steps are as follows:

Step 1: determining an action region of air route network.

Step 2: determining an effective airspace within the region.

Step 3: extracting an urban contour in the effective airspace of the region.

Step 4: constructing nodes in the urban contour.

Step 5: building an air route connecting side to form the initial air route network.

Step 6: introducing constraint conditions, determining multi-objective function, and optimizing center positions and connecting sides of UAVs to build an optimal air route network that meets the constraint conditions and achieves optimal multi-objective function.

The present application has the following advantages:

1, the present application provides the low-altitude air route planning and design method for UAV with multi-objective constraints, solves the management problems of the future UAVs over the city, compared with the applicable scope of other air route optimization, urban low-altitude of the present application is classified and differentiated, safety, economy, and reliability is fused to comprehensively optimize the air route, in combination with the urban low-altitude features and unmanned aerial vehicle (UAV) characteristics.

2, the present application provides the low-altitude air route planning and design method for UAV with multi-objective constraints, realizes determining the air initial route network according to the demand points, then realizes air route network of multi-objective optimization on the basis of the initial air route network, interacts with each other affects, realizes completely the air route network planning and optimization from scratch.

### BRIEF DESCRIPTION OF DRAWINGS

FIG. 1 is a flow chart of the low-altitude air route planning and design method of the UAV with multi-objective constraints.

FIG. 2 is a schematic diagram of urban contour extraction in the low-altitude air route planning and design method of UAV with multi-objective constraints.

FIG. 3 is a schematic diagram of urban demand points in the low-altitude air route planning and design method of UAV with multi-objective constraints.

FIG. 4 is a schematic diagram of the UAV center location selection way in low-altitude air route planning and design method of the UAV with multi-objective constraints.

FIG. 5 is a schematic diagram of initial construction of connecting sides in the low-altitude air route planning and design method of the UAV with multi-objective constraints.

FIG. 6 is a schematic diagram of air route network ARN.

### DESCRIPTION OF EMBODIMENTS

Further details of the present application are given in conjunction with the appended drawings.

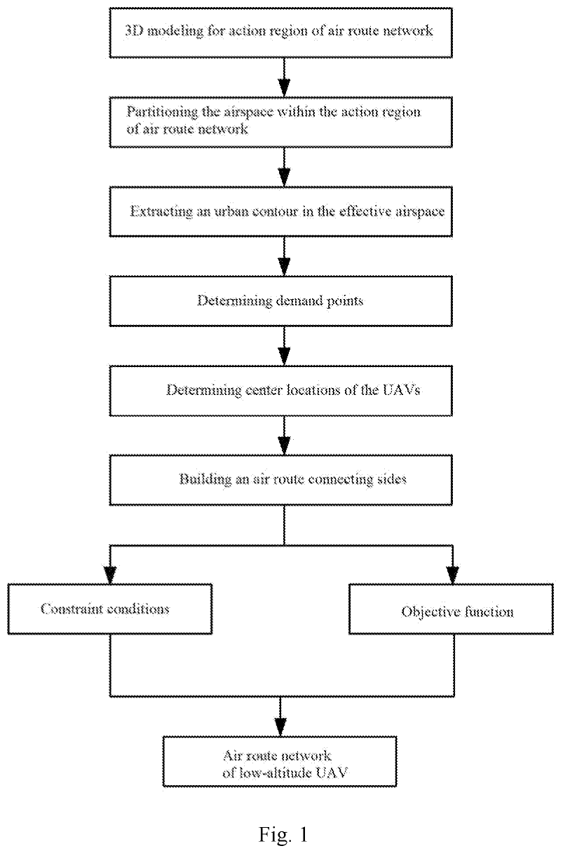

A low-altitude air route planning and design method of UAV with multi-objective constraints is presented in FIG. 1. The specific steps are as follows:

Step 1: Determining an action region of the air route network, and carrying out 3D modeling for this region.

Step 2: Partitioning the airspace within the region determined in Step 1.

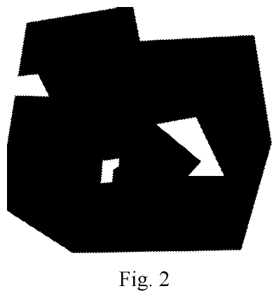

Since most urban areas all has the key areas such as hospitals, schools and so on, so in order to reduce the influence of the unmanned aerial vehicle (UAV) flight, and reduce the possibility of a mid-air collision, partition the airspace in the region. As shown in FIG. 2, the airspace is divided into free flight airspace, restricted airspace and ban airspace, wherein UAV can fly freely in the free flight airspace, UAV can fly restrictively only along the established air route in the restricted airspace, UAV must not enter to fly in the ban airspace. The effective airspace which the air route network functions is formed by the free flight airspace and restricted flight airspace above, together.

Step 3: Extracting an urban contour in the effective airspace of the region.

As shown in FIG. 2, based on the 3D modeling results of Step 1, an urban contour within the region acted by the air route network was extracted to provide data support for subsequent constraints.

Step 4: Initially constructing nodes in the urban contour.

For the UAV air route network, the short-term application is package delivery, while the long-term application should be transporting people or performing complex tasks. As a result, future demand points will be so large that they will be able to reach almost any point in the region under consideration. Because the nodes are not defined, the question becomes a new network design. In the process of designing nodes and sides without existing network, multiple design factors including location of dense traffic area, platform performance characteristics, the ground infrastructure, population density and supporting infrastructure and so on can be considered. And because the essence of the node location selection is continuous covering problem, as a NP (Non-deterministic Polynomial) problem, if the multiple design factors one-time are considered, on the one hand, the program complexity is increased, secondly multiple design factors may be mutual coupling and cause early convergence, the final network effect is poorer. Thus, in this step, only requirements coverage and cost issues can be considered, a preliminary network is built, then the work can be further refined.

The specific ways of initial node construction in the urban contour are as follows:

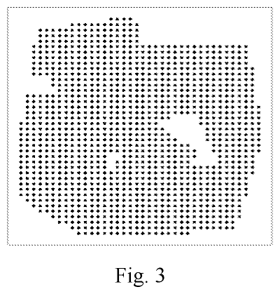

A: Analyzing the demand for UAV in the city, determining the demand area for UAV, and dividing this area into discrete demand points, as shown in FIG. 3.

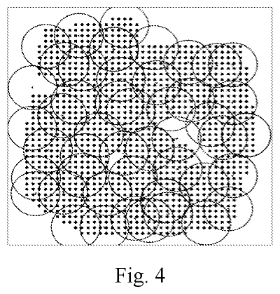

B: Using the limited coverage algorithm, selecting center positions of n UAVs as air route points from center positions of a number of candidate unmanned aerial vehicles (UAVs) (entity site location which provides service such as dock, loading and unloading, maintenance and so on for the unmanned aerial vehicles (UAVs)), making center coverage of the n UAVs covering all the urban demand points, as shown in FIG. 4, the concrete expression to maximize:

$${\sum }_{i ∈ I} {y}_{i}$$

And xᵢϵ{0,1}, jϵJ

yᵢϵ{0,1}, iϵI, I is a set of demand points,

$${\sum }_{j ∈ J} {x}_{j} = K \\ {d}_{i , j} \leq r$$

Where xⱼ represents whether the jth candidate UAV is selected, xⱼ is 1 when selected, and 0 when unselected. yᵢ represents whether the demand point i is covered, yᵢ is represented as 1 when the demand point i is covered by the center of UAV, and is represented as 0 when the demand point i is not covered by the center of UAV; I represents the set of demand points; J represents the set of the central locations of the candidate UAVs; d_{i,j} represents the distance from the demand point i to the center j of the UAV (Euclidean distance); K represents the number of center locations of the selected UAV; r represents the maximum distance between the demand point and the center location of the UAV

Step 5: Initially building an air route connecting sides to form the initial route network;

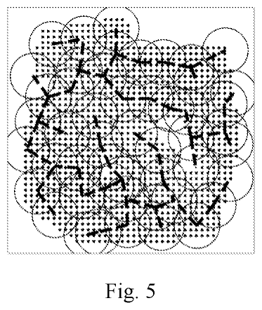

According to the center positions of the n UAVs determined in Step 4, Kruskal algorithm is used to connect them, forming the internally connected UAV air route network and forming the initial UAV air route network, as shown in FIG. 5. The specific method is as follows:

The relevant definitions of the algorithm for constructing the initial UAV air route network are as follows.

Effective UAV air route network: effective UAV air route network of an UAV air route network is a subgraph of an UAV air route network, it contains all n UAV centers in UAV route network, but only the n−1 sides. That is to say, an effective UAV air route network with n UAV centers has only n−1 sides. If an additional side is added to the effective UAV air route network, it must be a ring.

Minimum effective UAV air route network: in all effective UAV air route network of UAV air route network, the cost of all the sides and the minimum effective UAV air route network are known as the minimum effective UAV air route network.

First of all, the number of sides in the initial minimum effective UAV air route network is 0, and a minimum cost side is selected for each iteration to be added to the side set of the minimum effective UAV air route network. Then the connecting sides are built through the following steps:

(1) Sorting all sides in the side set of the minimum effective UAV air route network according to the cost from small to large.

(2) n UAV centers in the UAV air route network are regarded as an air route network set composed of independent n effective UAV air route networks.

(3) Selecting sides according to the weight from small to large, the two UAV centers, ui, vi connected by the selected side should belong to two different effective UAV air route network, the side would be a side of the least effective UAV air route network, and two effective UAV air route networks which the two UAV centers ui, vi belongs to can be merged as an effective UAV air route network.

(4) Repeating step (3) until all vertices are in an effective UAV air route network and the entire network has n−1 sides, forming the minimum effective UAV air route network.

Step 6: Optimizing the center positions and connecting sides of the UAVs.

ARN (Air Route Network) is the backbone Network of the national airspace, which affects the flight distance and operation efficiency of the Air transport system. All flights will strictly comply with ARN rules during air transportation. In addition, air traffic management activities such as aircraft stowage support, flight conflict resolution, air traffic volume control, navigation infrastructure construction and so on are mostly concentrated in the aircraft regional network.

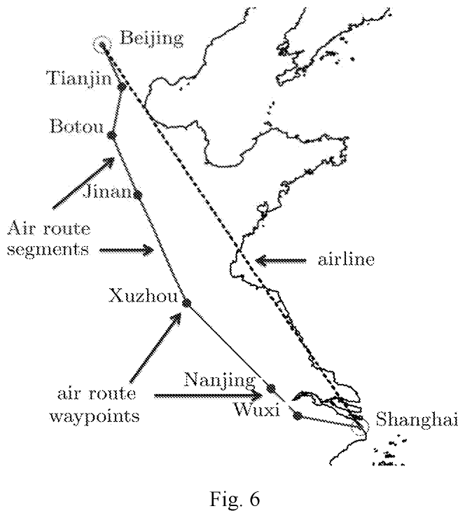

FIG. 6 is a schematic of ARN. It can be seen from the figure that the dashed line represents one of the busiest airlines in China—Beijing-Shanghai airline, while the solid line represents ARSs (Air Route Segments), which are connected through a series of ARWs (Air Route Waypoints). Therefore, the center positions of n UAVs selected in step B are adjusted and the air route connected sides are reconstructed to ensure the optimal multi-objective function while satisfying multi-constraint conditions.

The n UAV center locations selected in step 4 is as center of circle, new UAV center is formed by moving randomly in a given scope. After the movement of all UAV center positions, the step 5 is repeated to reconstruct air route connected sides, form new air route network, and judge whether the network meets the constraint conditions. If the constraint conditions are met, then the movement is effective. If the constraint conditions are not met, it returns to the air route network before the movement, and the above-mentioned process is carried out again. After the UAV center positions are moved each time, it is judged whether the multi-objective function reaches the optimal level. If the multi-objective function reaches the optimal level, the air route network optimization is completed; otherwise, the UAV center locations continue to be moved until the multi-objective function reaches the optimal level. Finally, an optimal air route network is formed to meet the constraint conditions and achieve the optimal multi-objective function.

The above constraint conditions are as follows:

a. Constraints on the average conflict number of per hour of nodes:

cₖ≤cₘₐₓ.

Wherein cₖ is the average conflict number of k hours, and cₘₐₓ is the threshold value of the average conflict number of one hour.

b. Three zone constraints:

$$\{ \begin{matrix}{P}_{{i}^{′}} = {P}_{{i}^{′} 1} + ( {P}_{{i}^{′} 2} - {P}_{{i}^{′} 1} ) {t}_{{i}^{′}} \\ ( {t}_{{i}^{′}} ∈ [ 0 , 1 ] and {i}^{′} = 1 , 2 , … , n ) \\ {P}_{{i}^{′} ' 1} , {P}_{{i}^{′} 2} ∈ P\end{matrix} .$$

Wherein i′ represents the airport node, P represents the set of network node location coordinates, P_{i′} represents the location of intermediate node i′ that meets the restriction of “three zones” and is generated in the course of air route layout. P_{i′1}, P_{i′2} is the vertex position information of three zones corresponding to P_{i′}, and t_{i′} is the scale coefficient of distance between P_{i′} and P_{i′1}, P_{i′2}.

c. Constraints on traffic demand:

$${\sum }_{j ∈ N} {y}_{R {i}^{′}} {x}_{R {j}^{′}} \geq {q}_{R {i}^{′}}$$

Wherein i′, j′ represent the airport node, N is the set of other nodes without i′, q_{Ri′} is the demand of airport node i′, y_{Ri′} is the traffic coefficient of airport node i′, and X_{Rj′} is the traffic capacity of airport node j′.

d. Traffic capacity constraints:

y_{i′j′}/C_{i′j′}≤1

Wherein i′, j′ represents the airport node, y_{i′j′} represents the traffic volume of the air route from airport node i′ to airport node j′, and C_{i′j′} is the traffic volume threshold of the route from airport node i′ to airport node j′.

e. Controller load constraints:

w_{i′j′}≤80% t_{i′j′}x_{i′j′}

Where, i′, j′ represents the airport node, w_{i′j′} represents the actual number of control instructions from the airport node i′ to the airport node j′, t_{i′j′} is the control coefficient of the air route from the airport node i′ to the airport node j′, and x_{i′j′} represents the traffic volume of the air route from the airport node i′ to the airport node j′.

The multi-objective function is as follows:

min Σf×d;

min Σc;

min ΣSDB;

Wherein the flight volume in the segment f multiplied by the length of the segment d, the minimum sum of their products represents the minimization of the operating cost of the air route network. The minimum accumulation of the average collision number per hour of air route network nodes c represents that the air route network has the best security; The standard deviation of betweenness (SDB) of the air route network nodes is minimized to maximize the airspace capacity/traffic capacity.

A low-altitude air route planning and design device for UAV with multi-objective constraints, the device comprises: a first processor, configured to determine an action region of air route network; a second processor, configured to determine an effective airspace within the region; a third processor, configured to extract an urban contour in the effective airspace of the region; a fourth processor, configured to construct nodes in the urban contour; a fifth processor, configured to build an air route connecting side to form the initial air route network; and a sixth processor, configured to introduce constraint conditions, determine multi-objective function, and optimize the center positions and the connecting sides of UAVs to build an optimal air route network that meets the constraint conditions and achieves the optimal multi-objective function.

The fourth processor comprises: A: a first subprocessor, configured to determine the demand area of UAV and divide the area into discrete demand points; and B: a second subprocessor, configured to select the central location of the UAV as the node by the limited coverage method.

The second subprocessor configured to select the central location of UAV is expressed as the maximization:

$${\sum }_{i ∈ I} {y}_{i}$$

And xⱼϵ{0,1}, jϵJ

yᵢϵ{0,1}, iϵI, I is a set of demand points

$${\sum }_{j ∈ J} {x}_{j} = K \\ {d}_{i , j} \leq r$$

wherein xⱼ represents whether the jth candidate UAV is selected, xⱼ is 1 when selected, and 0 when unselected. yᵢ represents whether the demand point i is covered, yᵢ is represented as 1 when the demand point i is covered by the center of UAV, and is represented as 0 when the demand point i is not covered by the center of UAV; I represents the set of demand points; J represents the set of the central locations of the candidate UAVs; d_{i,j} represents the distance from the demand point i to the center j of the UAV (Euclidean distance); K represents the number of center locations of selected UAVs; r represents the maximum distance between the demand point and the center location of the UAV.

According to the nodes constructed by the fourth processor, Kruskal algorithm is used to connect and constitute the internally connected UAV route network.

The fifth processor is configured that: firstly, the number of sides in the initial minimum effective UAV air route network is 0, and a minimum cost side is selected for each iteration to be added to the side set of the minimum effective UAV air route network, the fifth processor is configured to build the connecting sides comprises: (1) sorting all sides in the side set of the minimum effective UAV air route network according to the cost from the small to the large; (2) regarding n UAV centers in the UAV air route network as an air route network set composed of independent n effective UAV air route networks; (3) selecting sides according to the weight from small to large, the two UAV centers, ui, vi connected by the selected side should belong to two different effective UAV air route network, the side would be a side of the least effective UAV air route network, and two effective UAV air route networks which the two UAV centers ui, vi belongs to can be merged as an effective UAV air route network; and (4) repeating selecting sides according to the weight from small to large until all vertices are in an effective UAV air route network and the entire network has n−1 sides, to the minimum effective UAV air route network.

The sixth processor is configured that: the nodes selected by the fourth processor is as center of circle, new UAV center is formed by moving randomly in a given scope, after the movement of all UAV center positions, the fifth processor is configured that building an air route connecting side is repeated to reconstruct air route connected sides, form new air route network, and judge whether the network meets the constraint conditions: if the constraint conditions are met, then the movement is effective, if the constraint conditions are not met, then it returns to the air route network before the movement, and the above-mentioned process is carried out again; after the UAV center positions are moved each time, it is judged whether the multi-objective function reaches the optimal level: if the multi-objective function reaches the optimal level, the air route network optimization is completed; otherwise, the UAV center locations continue to be moved until the multi-objective function reaches the optimal level.

The constraint conditions introduced by the sixth processor is following:

a. constraints on the average conflict number of per hour of nodes:

cₖ≤cₘₐₓ.

wherein cₖ is the average conflict number of k hours, and cₘₐₓ is the threshold value of the average conflict number of one hour;

b. three zone constraints:

$$\{ \begin{matrix}{P}_{{i}^{′}} = {P}_{{i}^{′} 1} + ( {P}_{{i}^{′} 2} - {P}_{{i}^{′} 1} ) {t}_{{i}^{′}} \\ ( {t}_{{i}^{′}} ∈ [ 0 , 1 ] and {i}^{′} = 1 , 2 , … , n ) \\ {P}_{{i}^{′} ' 1} , {P}_{{i}^{′} 2} ∈ P\end{matrix} .$$

wherein i′ represents the airport node, P represents the set of network node location coordinates, P_{i′} represents the location of intermediate node i′ that meets the restriction of “three zones” and is generated in the course of route layout. P_{i′1}, P_{i′2} is the vertex position information of three zones corresponding to P_{i′}, and t_{i′} is the scale coefficient of distance between P_{i′} and P_{i′1}, P_{i′2};

c. constraints on traffic demand:

$${\sum }_{j ∈ N} {y}_{R {i}^{′}} {x}_{R {j}^{′}} \geq {q}_{R {i}^{′}} .$$

wherein i′, j′ represent the airport node, N is the set of other nodes without i′, q_{Ri′} is the demand of airport node i′, y_{Ri′} is the traffic coefficient of airport node i′, and x_{Rj′} is the traffic capacity of airport node j′;

d. traffic capacity constraints:

y_{i′j′}/C_{i′j′}≤1.

wherein i′, j′ represents the airport node, y_{i′j′} represents the traffic volume of the air route from airport node i′ to airport node j′, and C_{i′j′} is the traffic volume threshold of the air route from airport node i′ to airport node j′; and

e. controller load constraints:

w_{i′j′}≤80% t_{i′j′}x_{i′j′}

wherein i′, j′ represents the airport node, w_{i′j′} represents the actual number of control instructions from the airport node i′ to the airport node j′, t_{i′j′} is the control coefficient of the air route from the airport node i′ to the airport node j′, and x_{i′j′} represents the traffic volume of the air route from the airport node i′ to the airport node j′.

The multi-objective functions determined by the sixth processor is following:

min Σf×d;

min Σc;

min ΣSDB;

wherein the flight volume in the segment f multiplied by the length of the segment d, the minimum sum of their products represents the minimization of the operating cost of the air route network; the minimum accumulation of the average collision number per hour of air route network nodes c represents that the air route network has the best security; the standard deviation of betweenness (SDB) of the air route network nodes is minimized to maximize the airspace capacity/traffic capacity.

Each of the first processor, the second processor, the third processor, the fourth processor, the fifth processor and the sixth processor is independent processor, or all of them are integrated in a single processor. All of the first subprocessor and the second subprocessor are integrated in a single processor.

A storage medium, wherein, the storage medium stores the program code; after the program code is loaded, it can be used to execute the method: the method comprises the following steps: step 1: determining an action region of air route network; step 2: determining an effective airspace within the region; step 3: extracting an urban contour in the effective airspace of the region; step 4: constructing nodes in the urban contour; step 5: building an air route connecting side to form the initial air route network; and step 6: introducing constraint conditions, determining multi-objective function, and optimizing the center positions and the connecting sides of UAVs to build an optimal air route network that meets the constraint conditions and achieves the optimal multi-objective function.

The application realizes the design of air route network and optimization of air route network, and proposes a complete air route network planning process for future UAV control, which is widely applicable and can provide corresponding air route network planning schemes for different cities.

The foregoing descriptions of specific exemplary embodiments of the present application have been presented for purposes of illustration and description. They are not intended to be exhaustive or to limit the application to the precise forms disclosed, and obviously many modifications and variations are possible in light of the above teachings. The exemplary embodiments were chosen and described in order to explain certain principles of the application and their practical application, to thereby enable others skilled in the art to make and utilize various exemplary embodiments of the present application, as well as various alternatives and modifications thereof. It is intended that the scope of the application be defined by the Claims appended hereto and their equivalents.

What is claimed is:

1. A low-altitude air route planning and design method for UAV with multi-objective constraints, comprising the following steps:
step 1: determining an action region of air route network;
step 2: determining an effective airspace within the region;
step 3: extracting an urban contour in the effective airspace of the region;
step 4: constructing nodes in the urban contour;
step 5: building an air route connecting side to form the initial air route network; and
step 6: introducing constraint conditions, determining multi-objective function, and optimizing the center positions and the connecting sides of UAVs to build an optimal air route network that meets the constraint conditions and achieves the optimal multi-objective function.

2. The low-altitude air route planning and design method for UAV with multi-objective constraints in claim 1, wherein the constructing nodes in the urban contour in step 4 comprises:
A: determining the demand area of UAV and divide the area into discrete demand points; and
B: selecting the central location of the UAV as the node by the limited coverage method.

3. The low-altitude air route planning and design method for UAV with multi-objective constraints in claim 2, wherein selecting the central location of UAV is expressed as the maximization:
$${\sum }_{i ∈ I} {y}_{i}$$
and xⱼϵ{0,1},jϵJ
yᵢϵ{0,1}, iϵI, I is a set of demand points
$${\sum }_{j ∈ J} {x}_{j} = K \\ {d}_{i , j} \leq r$$
wherein xⱼ represents whether the jth candidate UAV is selected, xⱼ is 1 when selected, and 0 when unselected; yᵢ represents whether the demand point i is covered, yᵢ is represented as 1 when the demand point i is covered by the center of UAV, and is represented as 0 when the demand point i is not covered by the center of UAV; I represents the set of demand points; J represents the set of the central locations of the candidate UAVs; d_{i,j} represents the distance from the demand point i to the center j of the UAV (Euclidean distance); K represents the number of center locations of selected UAVs; r represents the maximum distance between the demand point and the center location of the UAV.

4. The low-altitude air route planning and design method for UAV with multi-objective constraints in claim 1, wherein according to the nodes constructed in step 4, Kruskal algorithm is used to connect and constitute the internally connected UAV route network.

5. The low-altitude air route planning and design method for UAV with multi-objective constraints in claim 4, further comprising:
firstly, the number of sides in the initial minimum effective UAV air route network is 0, and a minimum cost side is selected for each iteration to be added to the side set of the minimum effective UAV air route network;
then building the connecting sides through the following steps:
(1) sorting all sides in the side set of the minimum effective UAV air route network according to the cost from the small to the large;
(2) regarding n UAV centers in the UAV air route network as an air route network set composed of independent n effective UAV air route networks;
(3) selecting sides according to the weight from small to large, the two UAV centers, ui, vi connected by the selected side should belong to two different effective UAV air route network, the side would be a side of the least effective UAV air route network, and two effective UAV air route networks which the two UAV centers ui, vi belongs to can be merged as an effective UAV air route network; and
(4) repeating step (3) until all vertices are in an effective UAV air route network and the entire network has n−1 sides, to the minimum effective UAV air route network.

6. The low-altitude air route planning and design method for UAV with multi-objective constraints in claim 1, wherein the step 6 comprises:
the nodes selected in step 4 is as center of circle, new UAV center is formed by moving randomly in a given scope, after the movement of all UAV center positions, the step 5 is repeated to reconstruct air route connected sides, form new air route network, and judge whether the network meets the constraint conditions: if the constraint conditions are met, then the movement is effective, if the constraint conditions are not met, then it returns to the air route network before the movement, and the above-mentioned process is carried out again; after the UAV center positions are moved each time, it is judged whether the multi-objective function reaches the optimal level: if the multi-objective function reaches the optimal level, the air route network optimization is completed; otherwise, the UAV center locations continue to be moved until the multi-objective function reaches the optimal level.

7. The low-altitude air route planning and design method for UAV with multi-objective constraints in claim 1, wherein the constraint conditions in the step 6 is following:
a. constraints on the average conflict number of per hour of nodes:
cₖ≤Cₘₐₓ
wherein cₖ is the average conflict number of k hours, and cₘₐₓ is the threshold value of the average conflict number of one hour;
b. three zone constraints:
$$\{ \begin{matrix}{P}_{{i}^{′}} = {P}_{{i}^{′} 1} + ( {P}_{{i}^{′} 2} - {P}_{{i}^{′} 1} ) {t}_{{i}^{′}} \\ ( {t}_{{i}^{′}} ∈ [ 0 , 1 ] and {i}^{′} = 1 , 2 , … , n ) \\ {P}_{{i}^{′} ' 1} , {P}_{{i}^{′} 2} ∈ P\end{matrix} ,$$
wherein i′ represents the airport node, P represents the set of network node location coordinates, P_{i′} represents the location of intermediate node i′ that meets the restriction of “three zones” and is generated in the course of route layout; P_{i′1}, P_{i′2} is the vertex position information of three zones corresponding to P_{i′}, and t_{i′} is the scale coefficient of distance between P_{i′} and P_{i′1}, P_{i′2};
c. constraints on traffic demand:
$${\sum }_{j ∈ N} {y}_{R {i}^{′}} {x}_{R {j}^{′}} \geq {q}_{R {i}^{′}}$$
wherein i′, j′ represent the airport node, N is the set of other nodes without i′, q_{Ri′} is the demand of airport node i′, y_{Ri′} is the traffic coefficient of airport node i′, and x_{Rj′} is the traffic capacity of airport node j′;
d. traffic capacity constraints:
y_{i′j′}/C_{i′j′}≤1
wherein i′, j′ represents the airport node, y_{i′j′} represents the traffic volume of the air route from airport node i′ to airport node j′, and C_{i′j′} is the traffic volume threshold of the air route from airport node i′ to airport node j′; and
e. controller load constraints:
w_{i′j′}≤80% t_{i′j′}x_{i′j′}
wherein i′, j′ represents the airport node, w_{i′j′} represents the actual number of control instructions from the airport node i′ to the airport node j′, t_{i′j′} is the control coefficient of the air route from the airport node i′ to the airport node j′, and x_{i′j′} represents the traffic volume of the air route from the airport node i′ to the airport node j′.

8. The low-altitude air route planning and design method for UAV with multi-objective constraints in claim 1, wherein the multi-objective functions in the step 6 is following:
min Σf×d;
min Σc;
min ΣSDB;
wherein the flight volume in the segment f multiplied by the length of the segment d, the minimum sum of their products represents the minimization of the operating cost of the air route network; the minimum accumulation of the average collision number per hour of air route network nodes c represents that the air route network has the best security; the standard deviation of betweenness (SDB) of the air route network nodes is minimized to maximize the airspace capacity/traffic capacity.

9. A low-altitude air route planning and design device for UAV with multi-objective constraints, wherein the device comprises:
a first processor, configured to determine an action region of air route network;
a second processor, configured to determine an effective airspace within the region;
a third processor, configured to extract an urban contour in the effective airspace of the region;
a fourth processor, configured to construct nodes in the urban contour;
a fifth processor, configured to build an air route connecting side to form the initial air route network; and
a sixth processor, configured to introduce constraint conditions, determine multi-objective function, and optimize the center positions and the connecting sides of UAVs to build an optimal air route network that meets the constraint conditions and achieves the optimal multi-objective function.

10. The low-altitude air route planning and design device for UAV with multi-objective constraints in claim 9, wherein the fourth processor comprises:
A: a first subprocessor, configured to determine the demand area of UAV and divide the area into discrete demand points; and
B: a second subprocessor, configured to select the central location of the UAV as the node by the limited coverage method.

11. The low-altitude air route planning and design device for UAV with multi-objective constraints in claim 10, wherein the second subprocessor configured to select the central location of UAV is expressed as the maximization:
$${\sum }_{i ∈ I} {y}_{i}$$
and xⱼϵ{0,1}, jϵJ
yⱼϵ{0,1}, iϵI, I is a set of demand points
$${\sum }_{j ∈ J} {x}_{j} = K \\ {d}_{i , j} \leq r$$
wherein xⱼ represents whether the jth candidate UAV is selected, xⱼ is 1 when selected, and 0 when unselected; yᵢ represents whether the demand point i is covered, yᵢ is represented as 1 when the demand point i is covered by the center of UAV, and is represented as 0 when the demand point i is not covered by the center of UAV; I represents the set of demand points; J represents the set of the central locations of the candidate UAVs; d_{i,j} represents the distance from the demand point i to the center j of the UAV (Euclidean distance); K represents the number of center locations of selected UAVs; r represents the maximum distance between the demand point and the center location of the UAV.

12. The low-altitude air route planning and design device for UAV with multi-objective constraints in claim 9, wherein according to the nodes constructed by the fourth processor, Kruskal algorithm is used to connect and constitute the internally connected UAV route network.

13. The low-altitude air route planning and design device for UAV with multi-objective constraints in claim 12, wherein the fifth processor is configured that:
firstly, the number of sides in the initial minimum effective UAV air route network is 0, and a minimum cost side is selected for each iteration to be added to the side set of the minimum effective UAV air route network;
the fifth processor is configured to build the connecting sides comprises:
(1) sorting all sides in the side set of the minimum effective UAV air route network according to the cost from the small to the large;
(2) regarding n UAV centers in the UAV air route network as an air route network set composed of independent n effective UAV air route networks;
(3) selecting sides according to the weight from small to large, the two UAV centers, ui, vi connected by the selected side should belong to two different effective UAV air route network, the side would be a side of the least effective UAV air route network, and two effective UAV air route networks which the two UAV centers ui, vi belongs to can be merged as an effective UAV air route network; and
(4) repeating selecting sides according to the weight from small to large until all vertices are in an effective UAV air route network and the entire network has n−1 sides, to the minimum effective UAV air route network.

14. The low-altitude air route planning and design device for UAV with multi-objective constraints in claim 9, wherein the sixth processor is configured that:
the nodes selected by the fourth processor is as center of circle, new UAV center is formed by moving randomly in a given scope, after the movement of all UAV center positions, the fifth processor is configured that building an air route connecting side is repeated to reconstruct air route connected sides, form new air route network, and judge whether the network meets the constraint conditions: if the constraint conditions are met, then the movement is effective, if the constraint conditions are not met, then it returns to the air route network before the movement, and the above-mentioned process is carried out again; after the UAV center positions are moved each time, it is judged whether the multi-objective function reaches the optimal level: if the multi-objective function reaches the optimal level, the air route network optimization is completed; otherwise, the UAV center locations continue to be moved until the multi-objective function reaches the optimal level.

15. The low-altitude air route planning and design device for UAV with multi-objective constraints in claim 9, wherein the constraint conditions introduced by the sixth processor is following:
a. constraints on the average conflict number of per hour of nodes:
cₖ≤cₘₐₓ
wherein cₖ is the average conflict number of k hours, and cₘₐₓ is the threshold value of the average conflict number of one hour;
b. three zone constraints:
$$\{ \begin{matrix}{P}_{{i}^{′}} = {P}_{{i}^{′} 1} + ( {P}_{{i}^{′} 2} - {P}_{{i}^{′} 1} ) {t}_{{i}^{′}} \\ ( {t}_{{i}^{′}} ∈ [ 0 , 1 ] and {i}^{′} = 1 , 2 , … , n ) \\ {P}_{{i}^{′} ' 1} , {P}_{{i}^{′} 2} ∈ P\end{matrix}$$
wherein i′ represents the airport node, P represents the set of network node location coordinates, P_{i′} represents the location of intermediate node i′ that meets the restriction of “three zones” and is generated in the course of route layout; P_{i′1}, P_{i′2} is the vertex position information of three zones corresponding to P_{i′}, and t_{i′} is the scale coefficient of distance between P_{i′} and P_{i′1}, P_{i′2};
c. constraints on traffic demand:
$${\sum }_{j ∈ N} {y}_{R {i}^{′}} {x}_{R {j}^{′}} \geq {q}_{R {i}^{′}}$$
wherein i′, j′ represent the airport node, N is the set of other nodes without i′, q_{Ri′} is the demand of airport node i′, y_{Ri′} is the traffic coefficient of airport node i′, and x_{Rj′} is the traffic capacity of airport node j′;
d. traffic capacity constraints:
y_{i′j′}/C_{i′j′}≤1
wherein i′, j′ represents the airport node, y_{i′j′} represents the traffic volume of the air route from airport node i′ to airport node j′, and C_{i′j′} is the traffic volume threshold of the air route from airport node i′ to airport node j′; and
e. controller load constraints:
w_{i′j′}≤80% t_{i′j′}x_{i′j′}
wherein i′, j′ represents the airport node, w_{i′j′} represents the actual number of control instructions from the airport node i′ to the airport node j′, t_{i′j′} is the control coefficient of the air route from the airport node i′ to the airport node j′, and x_{i′j′} represents the traffic volume of the air route from the airport node i′ to the airport node j′.

16. The low-altitude air route planning and design device for UAV with multi-objective constraints in claim 9, wherein the multi-objective functions determined by the sixth processor is following:
min Σf×d;
min Σc;
min ΣSDB;
wherein the flight volume in the segment f multiplied by the length of the segment d, the minimum sum of their products represents the minimization of the operating cost of the air route network; the minimum accumulation of the average collision number per hour of air route network nodes c represents that the air route network has the best security; the standard deviation of betweenness (SDB) of the air route network nodes is minimized to maximize the airspace capacity/traffic capacity.

17. A low-altitude air route planning and design storage medium for UAV with multi-objective constraints, wherein, the storage medium stores the program code; after the program code is loaded, it can be used to execute the method according to claim 1.
